(19) United States
(12) Patent Application Publication
(10) Pub. No.: US 2015/0307673 A1
(43) Pub. Date: Oct. 29, 2015

(54) TERPOLYMERS AND FILMS PRODUCED THEREFROM

(71) Applicant: ARKEMA FRANCE, Colombes (FR)

(72) Inventors: Fabrice DOMINGUES DOS SANTOS, Lyon (FR); Thierry LANNUZEL, Villeurbanne (FR); Shihai ZHANG, State College, PA (US)

(73) Assignee: ARKEMA FRANCE, COLOMBES (FR)

(21) Appl. No.: 14/650,399

(22) PCT Filed: Dec. 9, 2013
(86) PCT No.: PCT/FR2013/052995

§ 371 Date: Jun. 8, 2015

(30) Foreign Application Priority Data
Dec. 11, 2012 (FR) 1261885

(51) Int. Cl. C08J 5/18; D01F 6/32; C08F 214/22

(52) U.S. Cl. CPC C08J 5/18; C08F 214/22; D01F 6/32; C08J 2327/16

(57) ABSTRACT

The invention relates to a polymer comprising structural units of vinylidene fluoride, trifluoroethylene and chlorotrifluoroethylene, the molar ratio between the vinylidene fluoride and the trifluoroethylene in the polymer being between 55:45 and 65:35, and the molar proportion of the structural units of chlorotrifluoroethylene in the polymer being between 1.5 and 4.5%. The invention also relates to various items comprising said polymer, such as films, fibres, extruded plates and moulded items.

### TECHNICAL FIELD

The present invention relates to terpolymers obtained by polymerizing vinylidene fluoride (VDF), trifluoroethylene (TrFE) and chlorotrifluoroethylene (CTFE), as well as to the use of said terpolymers for making various articles such as films, fibers, extruded plates and molded articles.

### TECHNICAL BACKGROUND

Ferroelectric and relaxor ferroelectric materials that generate mechanical actuation induced by an external electric field have attracted a great deal of attention and have been recognized for applications in a variety of transducers, actuators and sensors. Among these materials, VDF/TrFE-based copolymers have been extensively studied.

In particular, it is known to produce actuators based on stacked electroded thin films of VDF/TrFE-based terpolymers. It is desirable that these actuators be activated with a low electric voltage (such as below 150 V or even below 50 V), which necessitates a thin film thickness. On the other hand, the polymer films must have sufficient rigidity so that they can be easily manipulated and do not have a high risk of breaking and deforming during production. Besides, they must also have a high density of elastic energy when subjected to an electric field of 50 to 100 V/μm.

Document EP 206 926 describes dielectric materials consisting of an alloy of ferroelectric polymers having different Curie temperatures. Alloys comprising VDF-, TrFE- and CTFE-based terpolymers are used, inter alia, the molar ratio of CTFE in said terpolymers being 5% or 10% (curves 14 and 15, respectively, FIG. 6). The alloys are produced by melt-blending the various components, the mixtures obtained then being pressed in the form of films of 100 to 200 μm.

Document U.S. Pat. No. 4,554,335 relates to dielectric polymer materials comprising 25 to 90 mol. % VDF, 5 to 70 mol. % TrFE and 1 to 13 mol. % CTFE. Suspension polymerization, solution polymerization and emulsion polymerization are cited as appropriate polymerization methods. The materials thus obtained are then hotpressed at 200° C. to form films having a thickness of typically 150 μm.

Document U.S. Pat. No. 4,543,293 relates to polarized shaped VDF-based copolymer materials. The copolymer comprises 40 to 87 mol. % VDF, 10 to 40 mol. % TrFE, and 3 to 20 mol. % vinyl fluoride (VF). They are prepared by bulk polymerization, and are cast with dimethylformamide as a solvent to obtain cast films of approximately 30 μm in thickness.

Document U.S. Pat. No. 5,087,679 describes a polymeric dielectric material composed of 60 to 79 mol. % of VDF, 18 to 22 mol. % of TrFE and 3 to 22 mol. % of CTFE. Films having a thickness of 3 mm are obtained by thermally pressing the polymer followed by quenching with water. Suspension polymerization, emulsion polymerization and solution polymerization may be used for preparing these polymers.

Document U.S. Pat. No. 6,355,749 discloses ferroelectric terpolymers comprising 50 to 80 mol. % VDF, 15 to 40 mol. % TrFE and 2 to 20 mol. % of a bulky monomer such as CTFE or hexafluoropropene (HFP). In the exemplified embodiments, the amount of CTFE ranges from 6.7 to 12.5 mol. %. The dielectric constant of these terpolymers is above 40, and 30 μm-thick films are prepared from these terpolymers. The manufacturing process taught by this document involves bulk polymerization and an oxygen-activated free radical initiated process.

The article Electrostrictive Properties of Poly(vinylidene fluoride-trifluoroethylene-chlorotrifluoroethylene), by Buckley et al. in Chem. Matters 14:2590-2593 (2002) relates to VDF/TrFE/CTFE polymers prepared by bulk polymerization and oxygen-activated free-radical initiation, containing CTFE levels of approximately 5-10 mol. % (actually 5.8 to 10.3 mol. % based on table 1). An average mechanical modulus of approximately 0.2 GPa is measured for these polymers.

The article High Electromechanical Responses in a Poly(vinylidene fluoride-trifluoroethylene-chlorofluoroethylene)terpolymer, by Xia et al. in Advanced Materials 14:1574-1577 (2002) describes a first terpolymer having a molar composition of 62 parts VDF, 38 parts TrFE and 4 parts CFE, and a second terpolymer having a molar composition of 65 parts VDF, 35 parts TrFE and 10 parts CTFE. The synthesis process is based on bulk polymerization. Films are produced by solvent casting and annealing, resulting in a film thickness of approximately 20 μm. The elastic modulus of the VDF/TrFE/CTFE polymer is said to be 0.4 GPa.

Document U.S. Pat. No. 6,787,238 is directed to terpolymer systems and their electromechanical and dielectric applications. The terpolymer systems are prepared by conventional polymerization methods such as suspension, emulsion or solution polymerization. The terpolymer systems are composed of 55 to 75 mol. % VDF, 15 to 35 mol. % TrFE, and the remainder of CTFE; or of 55 to 80 mol. % VDF, 15 to 40 mol. % TrFE, and the remainder of CFE. The dielectric constant of these terpolymer systems is above 40.

For example, document U.S. Pat. No. 7,078,101 describes high strain electrostrictive terpolymer films, comprising 65 to 71 mol. % VDF, 26 to 33 mol. % TrFE and 1 to 6 mol. % of a third monomer, which can be 1,1-chlorofluoroethylene (CFE) or 1,2-chlorofluoroethylene. The document does not contain any details on the polymerization process. Elastic modulus values of approximately 400 MPa are provided in the document.

Document U.S. Pat. No. 7,750,098 is directed to terpolymers made of 40 to 70 mol. % VDF, 20 to 40 mol. % TrFE, the remainder being CFE. The dielectric constant of these polymers is above 50, and the elastic modulus ranges from 300 to 350 MPa according to the example section. The polymers are manufactured using suspension polymerization, by continuously injecting all of the monomers into an autoclave at constant temperature and pressure. 30 μm-thick films are prepared based on these polymers.

Document WO 2010/116105 teaches a method for the production of terpolymers based on VDF, TrFE and CFE or CTFE comprising an initial loading of two first monomers, and then a continuous addition of all of the monomers into the reactor, at constant pressure. The polymers thus obtained are characterized by a VDF molar content of 30 to 80%, a TrFE molar content of 5 to 60%, and a CFE or CTFE molar content of 3 to 20%. According to the preferred embodiment, the VDF content is 61.8 mol. %, the TrFE content is 29.8 mol. % and the CFE content is 8.5 mol. %. The dielectric constant of these polymers is above 50.

The article Relaxor Fluorinated Polymers: novel applications and recent developments, in IEEE Trans. Diel. El. Insul., 17:1106-1112 (2010) describes a first terpolymer comprising 65 parts VDF, 35 parts TrFE and 8.6 parts CFE; and a second terpolymer comprising 66 parts VDF, 64 parts TrFE and 8.3 parts CTFE. The elastic modulus of the VDF/TrFE/CFE polymer is approximately 0.3-0.4 GPa.

In most of the above prior art documents, the elastic modulus of the VDF/TrFE-based polymer systems is relatively low, for instance less than 0.4 GPa for VDF/TrFE/CTFE polymers. It is thus desirable to provide further electroactive VDF/TrFE-based polymer systems having a higher elastic modulus, so that they can be more easily manipulated and further processed (for example metalized) especially when they are in the form of very thin films.

### SUMMARY OF THE INVENTION

It is a first object of the invention to provide a polymer comprising vinylidene fluoride, trifluoroethylene and chlorotrifluoroethylene structural units, the vinylidene fluoride-to-trifluoroethylene molar ratio in the polymer being from 55:45 to 65:35, and the molar proportion of chlorotrifluoroethylene structural units in the polymer being from 1.5 to 4.5%.

According to one embodiment, the polymer consists of vinylidene fluoride, trifluoroethylene and chlorotrifluoroethylene structural units.

According to one embodiment, the polymer has a weight average molecular weight of at least 100,000, preferably at least 200,000, and more preferably at least 300,000 or at least 400,000.

According to one embodiment, the molar proportion of chlorotrifluoroethylene structural units in the polymer is from 1.8 to 4.5%, preferably from 3.2% to 4.5%, and more preferably from 3.4% to 4.5%.

It is a second object of the invention to provide a polymer obtainable by a polymerization process starting from vinylidene fluoride, trifluoroethylene and chlorotrifluoroethylene monomers, the molar ratio of vinylidene fluoride monomers to trifluoroethylene monomers being from 55:45 to 65:35, and the molar proportion of chlorotrifluoroethylene monomers relative to the total of vinylidene fluoride, trifluoroethylene and chlorotrifluoroethylene monomers is from 1.5 to 4.5%.

According to one embodiment, the polymer has a weight average molecular weight of at least 100,000, preferably at least 200,000, and more preferably at least 300,000 or at least 400,000.

According to one embodiment, the molar proportion of chlorotrifluoroethylene monomers relative to the total of vinylidene fluoride, trifluoroethylene and chlorotrifluoroethylene monomers is from 1.8 to 4.5%, preferably from 3.2% to 4.5%, and more preferably from 3.4% to 4.5%.

According to one embodiment, the process is a suspension polymerization process.

According to one embodiment, the process comprises the following successive steps:
(1) loading a reactor with an initial mixture of monomers;
(2) adding a radical polymerization initiator to the reactor;
(3) continuously adding a second mixture of monomers to the reactor to perform polymerization at a substantially constant pressure.

According to one embodiment, the initial mixture comprises vinylidene fluoride and trifluoroethylene monomers, without chlorotrifluoroethylene monomers; and the second mixture comprises vinylidene fluoride, trifluoroethylene and chlorotrifluoroethylene monomers.

It is a third object of the invention to provide a polymer comprising vinylidene fluoride, trifluoroethylene and chlorotrifluoroethylene structural units, which is suitable for being formed into a film having an elastic modulus of at least 0.5 GPa, preferably at least 0.6 GPa.

According to one embodiment, the vinylidene fluoride-to-trifluoroethylene molar ratio is from 55:45 to 75:25, preferably from 55:45 to 65:35 or from 62:38 to 72:28; and/or the molar proportion of chlorotrifluoroethylene structural units in the polymer is from 1.5 to 5.5%, advantageously from 1.5 to 4.5%, preferably from 1.8 to 5.5%, or even from 1.8 to 4.5%, more preferably from 3.2% to 4.5%, and most preferably from 3.4% to 4.5%; and/or the polymer consists of vinylidene fluoride, trifluoroethylene and chlorotrifluoroethylene structural units.

According to one embodiment, the film:
has a dielectric constant of less than 40 at 1 kHz and 25° C.; and/or
has an electrostrictive strain at 25° C. of at least 0.25%, preferably at least 0.4%, under an electric field gradient of 50 MV/m; or of at least 0.7%, preferably at least 1%, under an electric field gradient of 100 MV/m; and/or
has a thickness of less than 30 μm, preferably a thickness of 1 to 5 μm, and more preferably a thickness of 1 to 3 μm.

According to one embodiment, the film is produced by solvent casting, by extrusion or by hot melt pressing, and then optionally stretched then annealed. The stretching (when performed) is done preferably by a factor of 2 to 10, more preferably 5 to 7.

It is another object of the invention to provide various articles comprising the polymer according to the invention, such as films, fibers, extruded plates and molded articles.

It is another object of the invention to provide a film comprising the polymer of any one of the above embodiments, or preferably consisting of the polymer of any one of the above embodiments.

According to one embodiment, the film has an elastic modulus of at least 0.5 GPa, preferably at least 0.6 GPa.

It is another object of the invention to provide a film comprising a polymer which comprises vinylidene fluoride, trifluoroethylene and chlorotrifluoroethylene structural units, the film having an elastic modulus of at least 0.5 GPa, preferably at least 0.6 GPa.

According to one embodiment, the vinylidene fluoride-to-trifluoroethylene structural units molar ratio in the polymer is from 55:45 to 75:25, preferably from 55:45 to 65:35 or from 62:38 to 72:28; and/or the molar proportion of chlorotrifluoroethylene structural units in the polymer is from 1.5 to 5.5%, advantageously from 1.5 to 4.5%, preferably from 1.8 to 5.5%, or even from 1.8 to 4.5%, more preferably from 3.2% to 4.5% and most preferably from 3.4% to 4.5%; and/or the polymer consists of vinylidene fluoride, trifluoroethylene and chlorotrifluoroethylene structural units.

According to one embodiment, the film has a dielectric constant of less than 40 at 1 kHz and 25° C.; and/or has an electrostrictive strain at 25° C. of at least 0.25%, preferably at least 0.4%, under an electric field gradient of 50 MV/m; or of at least 0.7%, preferably at least 1%, under an electric field gradient of 100 MV/m.

According to one embodiment, the film has a thickness of less than 30 μm, preferably a thickness of 1 to 5 μm, and more preferably a thickness of 1 to 3 μm.

It is another object of the invention to provide a method of making the polymer of any one of the above embodiments, comprising polymerizing vinylidene fluoride monomers, trifluoroethylene monomers and chlorotrifluoroethylene monomers.

According to one embodiment, the method is performed by suspension polymerization.

According to one embodiment, the method comprises the following successive steps:
(1) loading a reactor with an initial mixture of monomers;
(2) adding a radical polymerization initiator to the reactor;
(3) continuously adding a second mixture of monomers to the reactor to perform polymerization at a substantially constant pressure.

According to one embodiment, the initial mixture comprises vinylidene fluoride and trifluoroethylene monomers, without chlorotrifluoroethylene monomers; and the second mixture comprises vinylidene fluoride, trifluoroethylene and chlorotrifluoroethylene monomers.

According to one embodiment, the pressure in the reactor in steps (2) and (3) is at least 80 bar; and the temperature in the reactor in steps (2) and (3) is from 40 to 60° C.

It is another object of the invention to provide a method of manufacturing the film of any one of the above embodiments, comprising a step of producing a film, optionally a step of stretching said film, and a step of annealing said film. According to one embodiment, the step of producing a film is performed by solvent casting, by extrusion or by hot melt pressing, preferably by solvent casting, and more preferably by solvent casting the above composition.

The present invention makes it possible to overcome the drawbacks of the prior art. In particular the invention provides electroactive VDF/TrFE-based polymer systems having a higher elastic modulus, which can be easily manipulated and further processed (e.g. metallized) especially when they are formed into thin films. In particular, the polymers of the invention make it possible to manufacture thinner films than those obtained according to the prior art.

This is primarily achieved by selecting appropriate ratios of VDF, TrFE and CTFE monomers or structural units, and optionally by a proper adjustment of some features of the polymerization process.

According to particular embodiments, the invention also has one or preferably several of the following advantageous features:
CTFE is used as the third monomer, as this monomer is more readily available for industrial use and easier to implement. In particular, it does not need to be stabilized during storage, and it is easier to control during synthesis. No VDF/TrFE/CTFE terpolymer having a high elastic modulus of at least 0.5 GPa was reported in the prior art discussed above.
The dielectric constant of the polymer films of the invention is preferably less than 40. This makes it possible to reduce power consumption upon use of the material. The value of the dielectric constant primarily depends on the monomer composition of the polymer film.
The polymers of the invention are advantageously made by a suspension polymerization process comprising the continuous addition of monomers into the reactor. This process is easier to implement than conventional bulk polymerization (especially at the industrial scale), and it also has an impact on the structure of the resulting polymers, in particular the distribution of monomers within the polymers. Besides, the molecular weight of the resulting polymers is generally higher than that of polymers obtained by bulk polymerization, which is an important factor for producing films which can be stretched without failure. Even more advantageously, the initial polymerization step is performed with VDF and TrFE only (without the CTFE monomer). This ensures better homogeneity and better reproducibility.

### DESCRIPTION OF EMBODIMENTS

The invention will now be described in more detail without limitation in the following description. All percentages are molar percentages unless otherwise specified. Molecular weights are expressed in g/mol.

Although terpolymers having the claimed composition can be produced using any known method, such as emulsion polymerization, suspension polymerization, and solution polymerization, it is preferable to use the process described in WO 2010/116105.

In brief, the preferred process comprises the following steps:
Loading an initial mixture of VDF and TrFE (without CTFE) into a stirred autoclave containing water.
Heating the autoclave to a predetermined temperature, close to the polymerization temperature.
Injecting a radical polymerization initiator mixed with water into the autoclave, so as to reach a pressure in the autoclave which is preferably at least 80 bar, so as to form a suspension of VDF and TrFE monomers in water.
Injecting a second mixture of VDF, TrFE and CTFE into the autoclave.
As soon as the polymerization reaction starts, continuously injecting said second mixture into the autoclave reactor, so as to maintain the pressure at a substantially constant level of preferably at least 80 bar.

The radical polymerization initiator can be an organic peroxide such as a peroxydicarbonate. It is usually used in an amount of 0.1 to 10 g per kilogram of the total monomer loading. Preferably, the amount used will be 0.5 to 5 g/kg.

The initial mixture advantageously includes only VDF and TrFE in a proportion equal to that of the final desired polymer.

The second mixture advantageously has a composition which is adjusted so that the total monomer composition introduced into the autoclave, including the initial mixture and the second mixture, is equal or approximately equal to the composition of the final desired polymer.

The weight ratio of the second mixture to the initial mixture is preferably from 0.5 to 2, more preferably from 0.8 to 1.6.

Implementing this process with an initial mixture and a second mixture makes the process independent of the reaction initiation phase, which is often unpredictable. The terpolymers thus obtained are in the form of a powder, without crust or skin.

The pressure in the autoclave reactor is preferably from 80 to 110 bar, and the temperature is maintained at a level preferably from 40° C. to 60° C.

The second mixture is continuously injected into the autoclave. It can be compressed before being injected into the autoclave, for example using one compressor or two successive compressors, typically at a greater pressure than the pressure in the autoclave.

Although, according to some embodiments, additional monomers can be used as starting materials (in a minor amount, such as e.g. less than 5%, or less than 2%, or less than 1%), and therefore the resulting terpolymer of the invention can comprise a minor amount (such as e.g. less than 5%, or less than 2%, or less than 1%) of other structural units than those cited above, it is preferred that only VDF, TrFE and CTFE monomers are used as starting materials, so that the polymer is composed of three structural units only, i.e. VDF, TrFE and CTFE.

The respective amounts of the monomers used as starting materials, and accordingly the respective amounts of structural units in the polymer, are adjusted so that the elastic modulus has a desired value, and optionally so that the electrostrictive strain and/or the dielectric constant have desired values.

Generally, the VDF/TrFE molar ratio of the monomers used as starting materials and/or the VDF/TrFE molar ratio in the polymer is from 55:45 to 75:25, and more preferably from 62:38 to 72:28.

According to some embodiments, the VDF/TrFE molar ratio is from 55:45 to 56:44, or from 56:44 to 57:43, or from 57:43 to 58:42, or from 58:42 to 59:41, or from 59:41 to 60:40, or from 60:40 to 61:39, or from 61:39 to 62:38, or from 62:38 to 63:37, or from 63:37 to 64:36, or from 64:36 to 65:35, or from 65:35 to 66:34, or from 66:34 to 67:33, or from 67:33 to 68:32, or from 68:32 to 69:31, or from 69:31 to 70:30, or from 70:30 to 71:29, or from 71:29 to 72:28, or from 72:28 to 73:27, or from 73:27 to 74:24, or from 74:24 to 75:25.

Generally, the molar proportion of CTFE monomers relative to the total amount of monomers in the starting materials and/or the molar proportion of CTFE structural units in the polymer is from 1.5 to 4.5%. Preferred ranges are from 1.8 to 4.5%, preferably from 3.2% to 4.5%, and more preferably from 3.4% to 4.5%.

According to some embodiments, the molar proportion of CTFE is from 1.5 to 1.6%, or from 1.6 to 1.7%, or from 1.7 to 1.8%, or from 1.8 to 1.9%, or from 1.9 to 2.0%, or from 2.0 to 2.1%, or from 2.1 to 2.2%, or from 2.2 to 2.3%, or from 2.3 to 2.4%, or from 2.4 to 2.5%, or from 2.5 to 2.6%, or from 2.6 to 2.7%, or from 2.7 to 2.8%, or from 2.8 to 2.9%, or from 2.9 to 3.0%, or from 3.0 to 3.1%, or from 3.1 to 3.2%, or from 3.2 to 3.3%, or from 3.3 to 3.4%, or from 3.4 to 3.5%, or from 3.5 to 3.6%, or from 3.6 to 3.7%, or from 3.7 to 3.8%, or from 3.8 to 3.9%, or from 3.9 to 4.0%, or from 4.0 to 4.1%, or from 4.1 to 4.2%, or from 4.2 to 4.3%, or from 4.3 to 4.4%, or from 4.4 to 4.5%, or from 4.5 to 4.6%, or from 4.6 to 4.7%, or from 4.7 to 4.8%, or from 4.8 to 4.9%, or from 4.9 to 5.0%, or from 5.0 to 5.1%, or from 5.1 to 5.2%, or from 5.2 to 5.3%, or from 5.3 to 5.4%, or from 5.4 to 5.5%.

An example of a preferred polymer is characterized by a VDF/TrFE molar ratio of approximately 65:35 and a CTFE content of approximately 3.7%.

The VDF/TrFE molar ratio in the polymer can be determined by proton NMR. The polymer is dissolved in an appropriate deutered solvent and the NMR spectrum is recorded on an FT-NMR spectrometer equipped with a multi-nuclear probe. The hydrogen nucleus of the TrFE unit (CHF═CF₂) gives a distinctive signal at around 5 ppm, whereas the 2 hydrogen atoms of the CH₂ group of the VDF units give a broad unresolved peak centered at 3 ppm. The relative integration of both signals gives the relative abundance of both monomers, that is, their molar ratio.

The amount of CTFE can be determined via a measurement of the chlorine content by elemental analysis. The combination of both results makes it possible to calculate the molar composition of the terpolymer.

The weight average molar mass Mw of the polymer is preferably at least 100,000, preferably at least 200,000, and more preferably at least 300,000 or at least 400,000. It can be adjusted by modifying some process parameters, such as the temperature in the reactor, or by adding a transfer agent.

The molecular weight distribution can be estimated by SEC (Steric Exclusion Chromatography) with dimethylformamide (DMF) as an eluent, with a set of 3 columns of increasing porosity. The stationary phase is a styrene-DVB gel. The detection method is based on a refractive index measurement, and calibration is performed with polystyrene standards. The sample is put into solution at 0.5 g/L in DMF and filtered over a 0.45 μm nylon filter.

The molecular weight can also be evaluated by melt flow index measurement at 230° C. under 5 kg load according to ASTM D1238 (ISO 1133).

Moreover, the molecular weight may be further characterized by a solution viscosity measurement according to ISO 1628. Methyl ethyl ketone (MEK) is a preferred solvent of terpolymers for the determination of the viscosity index.

Films can be prepared using the terpolymer of the invention, for instance by solvent casting or extrusion or hot melt pressing, and subsequent annealing (i.e. heating, for example for a few hours at 100-120° C., and cooling).

For instance, a polymer powder can be dissolved in DMF at a concentration of 3%, and then filtered with a 1 μm filter. The solution can be poured onto a clean glass slide on a hotplate set up at 60° C. After drying for approximately 5 hours, the film can be peeled off and dried in a vacuum oven at 100° C. overnight. The dried film can be stretched in one direction with a stretching ratio of about 5-7. The stretched film can be annealed in a forced air oven at 80° C. for 5 hours, and then at a temperature between 105° C. and 120° C. for 3 hours.

The invention makes it possible to obtain thin films having a thickness which is as small as 1 to 5 μm, and preferably 1 to 3 μm. If necessary, films having an intermediate thickness of 15 to 25 μm are prepared first, and then are stretched by a factor of 2 to 10, preferably 5 to 7 (e.g. as described above), so as to obtain the desired final thickness.

The films of the invention are preferably characterized by a dielectric constant at 1 kHz and at 25° C. which is lower than 40, and more preferably lower than 30 or lower than 20.

In order to measure the dielectric characteristics of the polymer film, the film is metallized by sputtering 30 nm thick gold electrodes on both surfaces with a diameter of 12 mm. The metallized film specimen is held between two silver metal connectors inside a Delta Design oven. A QuadTech 7600 Plus impedance analyzer is used to measure the capacitance, dissipation factor, and dielectric constant as a function of temperature and frequency.

The films of the invention are also preferably characterized by an elastic modulus of at least 0.5 GPa, and more preferably at least 0.6 GPa, or at least 0.7 GPa, or at least 0.8 GPa, or at least 0.9 GPa or at least 1 GPa or at least 1.1 GPa or at least 1.2 GPa or at least 1.3 GPa or at least 1.4 GPa.

The measurement of the elastic modulus is performed according to ASTM D1708. Specimens are cut with a dog bone die cutter, with a width of 5 mm and a length of 22 mm. An Instron Model 5866 apparatus is used to measure the modulus. A 100 N load cell is used with a cross-head speed of 25.4 mm/min. The test temperature is 23° C. The secant modulus at 1% strain is used.

These films are also preferably characterized by an electrostrictive strain at 25° C. of at least 0.25%, preferably at least 0.4%, more preferably at least 1%, or at least 1.5%, under an electric field gradient of 50 MV/m. Alternatively, they can be characterized by an electrostrictive strain at 25° C. of at least 0.7%, preferably at least 1%, more preferably at least 1.5%, or at least 2%, or at least 2.5%, or at least 3%, under an electric field gradient of 100 MV/m. In some other embodiments, the electrostrictive strain under an electric field gradient of 100 MV/m is less than 3%, for instance less than 2.5% or less than 2%.

In order to measure the electrostrictive strain under the applied field, the strain specimen is metallized on both sides with a gold electrode of 25 mm×13 mm. The 13 mm direction is parallel to the stretching direction. Thin metal wires are adhered to the metallized area with silver epoxy. A small tension is applied on the metallized specimen of the order of 10-20 g (along the stretching direction), and an electric field is applied to the specimen. The change of the specimen dimension in the stretching direction is monitored by a Computar CCD camera which is connected to a computer using the LabView program. The strain is defined by the change of specimen length/original specimen length.

### EXAMPLES

The following examples illustrate the invention without limiting it.

### Example 1

In a 3-L stirred reactor filled with 2500 g of deionized water (DI) containing cellulosic ether as dispersing agent, 163 g of TrFE and 237 g of VDF were charged. Then the reactor was heated to the desired initiation temperature, this temperature being maintained throughout the polymerization at a value comprised between 40 and 60° C. The peroxydicarbonate initiator was then injected into the reactor and the reaction began. The consumption of the monomers led to a decrease in pressure that was compensated by continuously feeding the reactor with a VDF/TrFE/CTFE mixture of molar composition 60.6/32.6/6.8. The pressure was thus maintained in the range of 80 to 110 bar. When a quantity of 376 g of feed mixture was reached, the injection was stopped and the pressure dropped for half an hour. Then, the reactor was cooled down and degassed, and the product was unloaded and recovered as a slurry. This slurry was filtered and the wet powder was washed several times in pure DI water. Finally, the powder was dried in an oven at moderate temperature until constant weight. 570 g of dry powder was recovered (73% yield).

The NMR and chlorine elemental analyses gave the following composition: VF2:TrFE ratio: 65.4/34.6; CTFE content: 3.7 mol %.

Other characterizations were: MFI: 0.96 g/10 min, modulus: 622 MPa.

### Examples 2-8

The same protocol was used for the following examples. The initial monomer composition of the initial load in the autoclave and of the second mixture, as well as the initiator and transfer agent quantities were adjusted in order to obtain different final polymer compositions and different molecular weights.

The results are summarized in the table below:

| | VF2/ | | | | | Dielec- | Dielec- |
|---|---|---|---|---|---|---|---|
| Exam- | (VF2 + | CTFE | | Modu- | | tric | tric |
| ple | TrFE) | (mol. | | lus | Strain | Con- | Loss |
| No. | (mol. %) | %) | MFI | (MPa) | (%) | stant | (%) |
| 1 | 65.4 | 3.7 | 0.96 | 622 | 0.65 | 25 | 5 |
| 3 | 61.1 | 4.1 | 0.98 | 753 | 0.6 | 25 | 6 |
| 4 | 70.6 | 1.97 | 0.54 | 1158 | 0.27 | 19 | 5 |
| 5 | 73.7 | 3.1 | 0.71 | 1064 | 0.29 | 13 | 5 |
| 6 | 70.5 | 2.7 | 0.41 | 1119 | 0.27 | 21 | 5 |
| 7 | 69 | 8.5 | 0.67 | 215 | 0.75 | | |
| (comp.) | | | | | | | |
| 8 | 58.4 | 8.2 | 0.24 | 237 | 0.7 | | |
| (comp.) | | | | | | | |

The elastic modulus was determined on films which were stretched with a stretching ratio of 7 and annealed at 120° C.

The electrostrictive strain was measured at 50 V/μm.

The dielectric constant and dielectric loss were determined at 25° C. on films which had been stretched with a stretching ratio of 7 and annealed at 120° C.

### Example 9

### Up-Scaling

A pilot plant reactor 30 liters in size under vacuum is filled with 26.9 l of deionized/deoxygenated water containing 4 g of cellulosic ether as dispersing agent. Agitation speed is set at 280 rpm. Then, 1.3 kg of TrFE and 1.9 kg of VDF are charged and the reactor is heated to 45° C. Meanwhile, the previously prepared mixture of 3 monomers VDF, TrFE and CTFE with a composition of 60.2/33.1/6.7 mol % is compressed up to around 100 bar. Peroxydicarbonate initiator is then injected into the reactor and as soon as the reaction begins, the consumption of the monomers is compensated by the injection of the monomer mixture. The pressure is thus maintained at around 90 bar. When 2700 g of monomer mixture has been introduced, the injection is stopped and the pressure is dropped down to 44 bar. Then, the reactor is cooled down and degassed, and the product is unloaded from the reactor as a slurry. After filtration and washing, the wet powder is dried in an oven at moderate temperature until constant weight. 5 kg of dry powder are recovered (83% yield).

The composition of the terpolymer thus synthesized, as given by NMR analysis is 62.5/34.2/3.3 mol % for VDF/TrFE/CTFE respectively. The MFI is 0.12 g/10 min under 5 kg.

1. A polymer comprising vinylidene fluoride, trifluoroethylene and chlorotrifluoroethylene structural units, wherein the vinylidene fluoride-to-trifluoroethylene molar ratio in the polymer is from 55:45 to 65:35, and the molar proportion of chlorotrifluoroethylene structural units in the polymer is from 1.5 to 4.5%.

2. The polymer of claim 1, wherein the polymer consists of vinylidene fluoride, trifluoroethylene and chlorotrifluoroethylene structural units.

3. The polymer of claim 1, having a weight average molecular weight of at least 100,000, preferably at least 200,000, and more preferably at least 300,000 or at least 400,000.

4. The polymer of claim 1, wherein the molar proportion of chlorotrifluoroethylene structural units in the polymer is from 3.2% to 4.5%, and preferably from 3.4% to 4.5%.

5. A polymer comprising vinylidene fluoride, trifluoroethylene and chlorotrifluoroethylene structural units, which is suitable for being formed into a film having an elastic modulus of at least 0.6 GPa.

6. The polymer of claim 5, wherein the vinylidene fluoride-to-trifluoroethylene molar ratio is from 55:45 to 75:25, preferably from 55:45 to 65:35 or from 62:38 to 72:28; and/or the molar proportion of chlorotrifluoroethylene structural units in the polymer is from 1.5 to 5.5%, advantageously from 1.5 to 4.5%, preferably from 1.8 to 5.5% or even from 1.8 to 4.5%, more preferably from 3.2% to 4.5%, and most preferably from 3.4% to 4.5%; and/or wherein the polymer consists of vinylidene fluoride, trifluoroethylene and chlorotrifluoroethylene structural units.

7. The polymer of claim 5, wherein the film:
has a dielectric constant of less than 40 at 1 kHz and 25° C.; and/or
has an electrostrictive strain at 25° C. of at least 0.25%, preferably at least 0.4%, under an electric field gradient of 50 MV/m; or of at least 0.7%, preferably at least 1%, under an electric field gradient of 100 MV/m; and/or
has a thickness of less than 30 μm, preferably a thickness of 1 to 5 μm, and more preferably a thickness of 1 to 3 μm.

8. The polymer of claim 5, wherein the film is produced by solvent casting, by extrusion or by hot melt pressing, then optionally stretched by a factor of 2 to 10, preferably 5 to 7, and annealed.

9. An article comprising the polymer of claim 1, selected from films, fibers, extruded plates and molded articles.

10. A film comprising the polymer of claim 1, or preferably consisting of the polymer.

11. The film of claim 10, having an elastic modulus of at least 0.6 GPa.

12. A film comprising a polymer which comprises vinylidene fluoride, trifluoroethylene and chlorotrifluoroethylene structural units, wherein the film has an elastic modulus of at least 0.6 GPa.

13. The film of claim 12, wherein the vinylidene fluoride-to-trifluoroethylene molar ratio in the polymer is from 55:45 to 75:25, preferably from 55:45 to 65:35 or from 62:38 to 72:28; and/or the molar proportion of chlorotrifluoroethylene structural units in the polymer is from 1.5 to 5.5%, advantageously from 1.5 to 4.5%, preferably from 1.8 to 5.5%, or even from 1.8 to 4.5%, more preferably from 3.2% to 4.5%, and most preferably from 3.4% to 4.5%; and/or the polymer consists of vinylidene fluoride, trifluoroethylene and chlorotrifluoroethylene structural units.

14. The film of claim 10, having a dielectric constant of less than 40 at 1 kHz and 25° C.; and/or having an electrostrictive strain at 25° C. of at least 0.25%, preferably at least 0.4%, under an electric field gradient of 50 MV/m; or of at least 0.7%, preferably at least 1%, under an electric field gradient of 100 MV/m.

15. The film of claim 10, having a thickness of less than 30 μm, preferably a thickness of 1 to 5 μm, and more preferably a thickness of 1 to 3 μm.

16. A method of making the polymer of claim 1, comprising polymerizing vinylidene fluoride monomers, trifluoroethylene monomers and chlorotrifluoroethylene monomers.

17. The method of claim 16, which is performed by suspension polymerization.

18. The method of claim 16, comprising the following successive steps:
(1) loading a reactor with an initial mixture of monomers;
(2) adding a radical polymerization initiator to the reactor;
(3) continuously adding a second mixture of monomers to the reactor to perform polymerization at a substantially constant pressure.

19. The method of claim 18, wherein the initial mixture comprises vinylidene fluoride and trifluoroethylene monomers, without chlorotrifluoroethylene monomers; and
the second mixture comprises vinylidene fluoride, trifluoroethylene and chlorotrifluoroethylene monomers.

20. The method of claim 16, wherein the pressure in the reactor in steps (2) and (3) is at least 80 bar; and the temperature in the reactor in steps (2) and (3) is from 40 to 60° C.

21. A method of manufacturing the film of claim 10, comprising a step of producing a film, optionally a step of stretching said film, and a step of annealing said film.

22. The method of claim 21, wherein the step of producing a film is performed by solvent casting, by extrusion or by hot melt pressing, preferably by solvent casting, and more preferably by solvent casting the composition.
